(19) United States
(12) Patent Application Publication
(10) Pub. No.: US 2022/0005060 A1
(43) Pub. Date: Jan. 6, 2022

(54) METHOD AND DEVICE FOR PROVIDING COMMENT INPUT MODE

(71) Applicant: BEIJING BYTEDANCE NETWORK TECHNOLOGY CO., LTD., Beijing (CN)

(72) Inventor: Zichao XU, Beijing (CN)

(21) Appl. No.: 17/283,711

(22) PCT Filed: Jan. 9, 2020
(86) PCT No.: PCT/CN2020/071231

§ 371 Date: Apr. 8, 2021

(30) Foreign Application Priority Data
May 21, 2019 (CN) 201910425536.0

(51) Int. Cl. G06Q 30/02; G06F 3/0481; G06F 3/0488; G06Q 50/00

(52) U.S. Cl. CPC G06Q 30/0217; G06Q 30/0239; G06Q 50/01; G06F 3/04886; G06F 3/04812

(57) ABSTRACT

The present disclosure provides a method and device for providing a comment input mode, relating to the technical field of Internet comment. The method includes: detecting, in response to a request of a user to comment on an object to be commented, whether resource saving information about the object to be commented is available; if so, providing the resource saving information and the comment input mode to the user, wherein the comment input mode is for the user to input comment content about the object to be commented; if not, providing the comment input mode to the user. The present disclosure realizes that if resource saving information about the object to be commented is available when a user makes comments, he/she can not only get a comment input mode for the user to input the comment content about the object to be commented in one click, but also get the resource saving information, which not only reduces the operation steps of the user when commenting and improves the input experience of the user, but also improves the efficiency of users to obtain information, and enhances the user experience.

### CROSS-REFERENCE TO RELATED APPLICATION

The present application claims priority of a Chinese patent application No. 201910425536.0 entitled “Method and Device for Providing Comment Input Mode” filed on May 21, 2019 in the China National Intellectual Property Administration, the disclosure of which is incorporated by reference herein in its entirety.

### TECHNICAL FIELD

The present disclosure relates to the field of Internet comment technology, specifically, the present disclosure relates to a technology for providing a comment input mode.

### BACKGROUND

With the popularization of mobile terminals and the speeding up of the Internet, people are increasingly expressing their own views authentically and freely on the Internet, such as making different comments on the same thing or phenomenon or Internet content, and at the same time, these comments help others to get the correct information from them. In the prior art, when people want to comment, usually the user clicks a comment button to input a comment page, and then clicks a input box on the comment page before the input box pops up for the user to input the comment content, which is a complicated and tedious operation process; moreover, if the user wants to be informed of the corresponding discount information, it is not available, which reduces the efficiency of the user to obtain information and affects the user experience.

### SUMMARY

The purpose of the present disclosure is to solve at least one of the above-mentioned technical defects, simplify the operation process of users to make comments, improve the efficiency of users to obtain information, and enhance the user experience. The technical solutions adopted in the present disclosure are as follows.

According to a first aspect of the present disclosure, a method for providing a comment input mode is provided, which comprises:
detecting, in response to a request of a user to comment on an object to be commented, whether resource saving information about the object to be commented is available;
if the resource saving information is available, providing the resource saving information and the comment input mode to the user, wherein the comment input mode is for the user to input comment content about the object to be commented;
if the resource saving information is not available, provide the comment input mode to the user.

In an optional embodiment of the first aspect of the present disclosure, the resource saving information comprises at least one of the following:
he resource saving information being a coupon about the object content of the object to be commented;
the resource saving information being a cash rebate information about the object content of the object to be commented;
if the object to be commented being a video and the video including implicit presentation information, the resource saving information being a discount information of implicit presentation information matching the user-related information of the user.

In an optional embodiment of the first aspect of the present disclosure, if the comment input mode is a comment text input box, the text style of the comment text input box is different from the page style of the comment page formed by the comment about the object to be commented.

In an optional embodiment of the first aspect of the present disclosure, the providing the resource saving information and the comment input mode to the user comprises at least one of the following:
providing the resource saving information and the comment input mode to the user, wherein the resource saving information is located at the top of the comment text input box;
providing the resource saving information and the comment input mode to the user, wherein the resource saving information is located at the upper portion of and immediately adjacent to the comment text input box;
providing the resource saving information and the comment input mode to the user, wherein the resource saving information is located at the top of the comment page.

According to a second aspect of the present disclosure, a providing device for providing a comment input mode is provided, which comprises:
a detection module configured to detect, in response to a request of a user to comment on an object to be commented, whether resource saving information about the object to be commented is available; and
a providing module configured to:
if the resource saving information is available, providing the resource saving information and the comment input mode to the user, wherein the comment input mode is for the user to input comment content about the object to be commented;
if the resource saving information is not available, provide the comment input mode to the user.

In an optional embodiment of the second aspect of the present disclosure, the resource saving information comprises at least one of the following:
the resource saving information being a coupon about the object content of the object to be commented;
the resource saving information being a cash rebate information about the object content of the object to be commented;
if the object to be commented being a video and the video including implicit presentation information, the resource saving information being a discount information of implicit presentation information matching the user-related information of the user.

In an optional embodiment of the second aspect of the present disclosure, if the comment input mode is a comment text input box, the text style of the comment text input box is different from the page style of a comment page formed by a comment about the object to be commented.

In an optional embodiment of the second aspect of the present disclosure, the step of providing the resource saving information and the comment input mode to the user comprises at least one of the following:
providing the resource saving information and the comment input mode to the user, wherein the resource saving information is located at the top of the comment text input box;
providing the resource saving information and the comment input mode to the user, wherein the resource saving information is located at the upper portion of and immediately adjacent to the comment text input box;
providing the resource saving information and the comment input mode to the user, wherein the resource saving information is located at the top of the comment page.

According to a third aspect of the present disclosure, an electronic device is provided, which comprises: one or more processors; a memory for storing one or more programs; and, when the one or more programs are executed by the one or more processors, causing the one or more processors to perform a method as shown in any of the embodiments of the first aspect of the present disclosure.

According to a fourth aspect of the present disclosure, a computer-readable storage medium having a computer program stored thereon is provided, wherein the program, when executed by a processor, implements a method as shown in any of the embodiments of the first aspect of the present disclosure.

The technical embodiments provided by the present disclosure bring about the following beneficial effects.

The scheme of the embodiment of the disclosure is as follows: in response to a request of a user to comment on an object to be commented, it detects whether there is resource saving information about the object to be commented, if the resource saving information is available, providing the resource saving information and the comment input mode to the user, wherein the comment input mode is for the user to input comment content about the object to be commented; if the resource saving information is not available, provide the comment input mode to the user. Therefore, according to the scheme of the embodiment of the disclosure, if resource saving information about the object to be commented is available when a user makes comments, he/she can not only get a comment input mode for the user to input the comment content about the object to be commented in one click, but also get the resource saving information, which not only reduces the operation steps of the user when commenting and improves the input experience of the user, but also improves the efficiency of users to obtain information, and enhances the user experience.

### BRIEF DESCRIPTION OF THE DRAWINGS

In order to more clearly illustrate the technical solutions in the embodiments of the present disclosure, the following is a brief description of the accompanying drawings that need to be used in the description of the embodiments of the present disclosure.

FIG. 1 is a schematic structural diagram of a providing device for providing a comment input mode according to an embodiment of the present disclosure.

FIG. 2 is a schematic diagram illustrating that resource saving information provided to a user is located at the top of a comment text input box according to an embodiment of the present disclosure;

FIG. 3 is a schematic flowchart of a method for providing a comment input mode according to an embodiment of the present disclosure; and

FIG. 4 is a schematic structural diagram of an exemplary electronic device suitable for implementing an embodiment of the present disclosure.

### DETAILED DESCRIPTION

Embodiments of the present disclosure are described in detail below, and examples of the embodiments are shown in the accompanying drawings, wherein the same or similar designations from beginning to end indicate the same or similar components or components having the same or similar functions. The embodiments described below by reference to the accompanying drawings are exemplary and are intended only to explain the present disclosure and are not to be construed as limiting the present invention.

As will be understood by those skilled in the art, the singular forms “a”, “an”, “said” and “the” used herein may also include plural forms unless expressly stated. It should be further understood that the word “comprising” used in the specification of this disclosure means the presence of stated features, integers, steps, operations, elements and/or components, but does not exclude the presence or addition of one or more other features, integers, steps, operations, elements, components and/or groups thereof. It should be understood that when we refer to an element as being “connected” or “coupled” to another element, it may be directly connected or coupled to other elements, or there may be intermediate elements. In addition, “connected” or “coupled” as used herein may include wirelessly connected or wirelessly coupled. The term “and/or” as used herein includes all or any of the units and all combinations of one or more of the associated listed items.

In order to make the purpose, technical solutions and advantages of the present disclosure clearer, the following will be described in further detail in connection with the accompanying drawings.

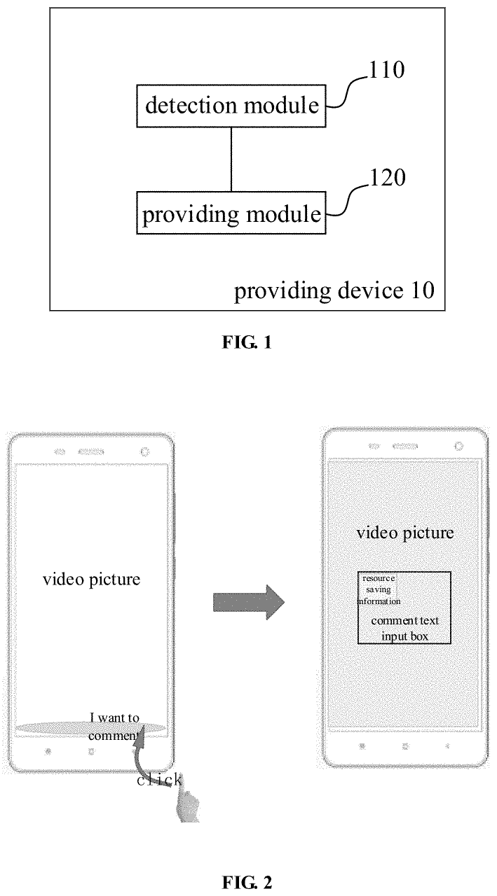

FIG. 1 is a schematic structural diagram of a providing device 10 for providing a comment input mode according to an embodiment of the present disclosure, wherein the providing device 10 includes a detection module 110 and a providing module 120. Alternatively, the detection module 110 detects, in response to a request of a user to comment on an object to be commented, whether resource saving information about the object to be commented is available. If the resource saving information is available, the providing module 120 provides the resource saving information and the comment input mode to the user, wherein the comment input mode is for the user to input comment content about the object to be commented. If the resource saving information is not available, the providing module 120 provides the comment input mode to the user.

Alternatively, the detection module 110 first obtains the user's request to comment on the object to be commented by means of dynamic page technology such as Java Server Pages (JSPs) or by means of an application program interface (API) provided by the providing device 10 itself, or obtains the request for commenting on the object to be commented by acquiring a natural language command from a user to comment on the object to be commented by a sound acquisition device (such as a microphone, etc.). Then, in response to the request, the detection module 110 detects whether resource saving information about the object to be commented is available, such as by searching in a resource saving information database based on the object content of the object to be commented, and thereby determining whether the corresponding resource saving information is available.

Here, the object to be commented may be a video, short video, picture, document, animation, etc. In this disclosure embodiment, the type of the object to be commented is not limited.

Here, the resource saving information refers to the discount information, and in practical application, the resource saving information includes, but is not limited to, at least one of the following: 1) the resource saving information being a coupon about the object content of the object to be commented; 2) the resource saving information being a cash rebate information about the object content of the object to be commented; 3) if the object to be commented being a video and the video including implicit presentation information, the resource saving information being a discount information of implicit presentation information matching the user-related information of the user. Where the implicit presentation information is the content incorporated into the object to be commented for conveying information to the user, such as a brand symbol representing a product or service incorporated into the video, where the user-related information is information that reflects the user's attributes, such as the user's gender, age, region, group, hobby, occupation, etc. Those skilled in the art should be able to understand that the above resource saving information and user-related information are examples only, and that other existing or possible future resource saving information or user-related information that may be applicable to the present disclosure should also be included within the scope of protection of the present disclosure and are hereby incorporated by reference herein.

In an optional embodiment, if the object to be commented is a video, the content of the video is the object content of the object to be commented. If the content of the video is related to gourmet food and the store corresponding to the gourmet food has promotional activities, the resource saving information may be coupons, cash rebate information, promotional information, etc. If the content of the video is about agricultural products and the origin of the agricultural products has promotional activities, the resource saving information may be coupons, discount information, promotion information, etc. For other contents of the video (such as children's playground, travel, etc.), and so on can get the corresponding resource saving information, here for the sake of simplicity, not to repeat.

In an optional embodiment, if the object to be commented is a short video about the promotion of attractions in poor counties to promote local tourism and boost the development of local tourism, the content of the video incorporates a number of implicit presentation information about local food, specialties, and food production materials, etc. If the user watching the short video has a hobby of food production, the corresponding resource saving information is the information about gourmet food. If the user watching the short video is interested in food preparation, the corresponding resource saving information is the discount information about the food preparation materials matching the user's hobby, rather than the discount information of other implicit presentation information incorporated in the short video.

In an optional embodiment, for example, assuming that user A views a short video with content about gourmet food, and he/she intends to comment on the video during the watching process, and then clicks the comment button on the page, the detection module 110 first obtains the request of user A to comment on the short video by means of dynamic page technology such as JSP; then, the detection module 110, based on the content of the video, performs a query in the resource saving database, so as to determine whether corresponding resource saving information is available, and if the detection module 110 queries in the resource saving information database and finds that the store corresponding to the gourmet food has discount information, then it can be judged that corresponding resource saving information is available.

Those skilled in the art should be able to understand that the above-mentioned ways of obtaining a user's request to comment on a subject to be commented on are only examples, and other existing or possible future ways of obtaining a user's request to comment on a subject to be commented on, if applicable to the present disclosure, should also be included within the scope of protection of the present disclosure, and are hereby included by reference herein.

It should be understood by those skilled in the art that the foregoing means of detecting the availability of resource saving information about the object to be commented is only an example, and that other existing or possible future means of detecting the availability of resource saving information about the object to be commented, if applicable to the present disclosure, should also be included within the scope of the present disclosure, and are hereby incorporated by reference herein.

If resource saving information is available, the providing module 120 provides the resource saving information and the comment input mode to the user via an agreed communication method such as HyperText Transfer Protocol (http) and HyperText Transfer Protocol Secure (https), where the comment input mode is for the user to input the comment content about the object to be commented through the comment input mode.

Here, the comment input mode may be a graphical user interface (GUI) interactive input mode, such as a comment text input box, or a voice interactive input mode, such as a microphone icon indicating voice input functionality.

In an optional embodiment, if the comment input mode is a comment text input box, the text style of the comment text input box is different from the page style of the comment page formed by the comment about the object to be commented. Here, the text style refers to the tone, font, and the like that reflects the formatting of the text in the comment text input box, and the style of the comment page refers to the page base color, the font of the text in the page, etc. For example, when the base color of the comment page is black, the comment text input by the user in the comment text input box is displayed in white, and when the base color of the comment page is white, the comment text input by the user in the comment text input box is displayed in black.

Here, the user's visual experience is enhanced because the text style of the comment text input box in the present disclosure is different from the page style of the comment page formed by the comment about the object to be commented.

In an optional embodiment, if the comment input mode is a comment text input box, the resource saving information and the comment input mode are provided to the user by the providing module 120 with the resource saving information located at the top of the comment text input box, or, the resource saving information is located at the upper portion of the comment text input box and immediately adjacent to the comment text input box, or, the resource saving information is located at the top of the comment page. For example, assuming that user A views a short video with content about gourmet food, and he/she intends to comment on the video during the watching process, and then clicks a comment button on the page (as shown in FIG. 2), if the detection module 110 queries the resource saving information database and finds that the store corresponding to the gourmet food has discount information, and therefore determines that it has corresponding resource saving information, then the providing module 120 provides the resource saving information and the comment text input box to the user A. Where the resource saving information is located at the top of the comment text input box, as shown in FIG. 2. In this regard, it is noted that FIG. 2 only exemplarily illustrates the case where the resource saving information is located at the top of the comment text input box, and the comment text input box in FIG. 2 hovers above the video window viewed by the user, which is also only exemplary and should not be interpreted as limiting the present disclosure. In practical applications, the location relationship between the comment text input box and the video window viewed by the user can be arbitrary and will not be limited here.

When the resource saving information and the comment input mode are provided to the user, the resource saving information is located at the top of the comment text input box, or the resource saving information is located at the upper portion of the comment text input box and immediately adjacent to the comment text input box, or the resource saving information is located at the top of the comment page, so that the user can immediately know the resource saving information, the efficiency of users to obtain information is further improved, and the user experience is further enhanced.

In an optional embodiment, if the comment input mode is a voice interactive input mode, the resource saving information is located at the top of the comment page formed by the comments about the object to be commented when the providing module 120 provides the resource saving information and the comment input mode to the user.

If the resource saving information is not available, the providing module 120 provides the comment input mode to the user.

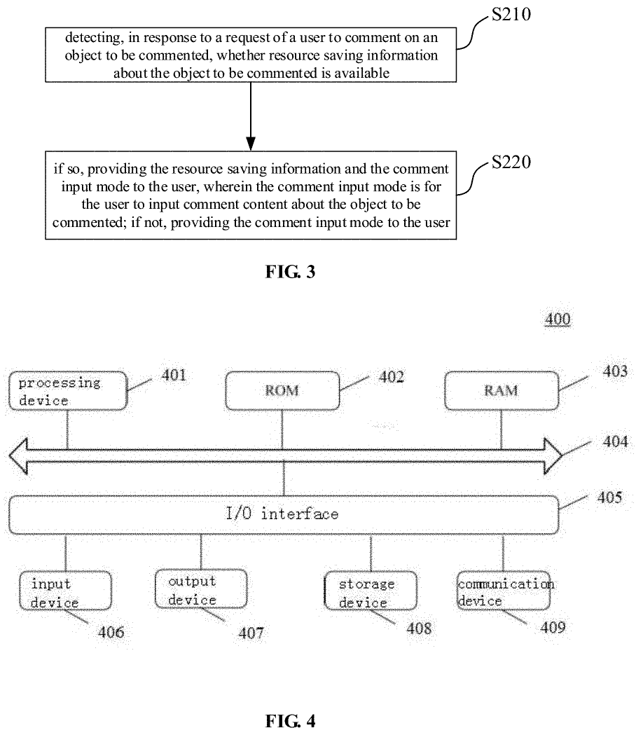

FIG. 3 is a schematic flowchart of a method for providing a comment input mode according to an embodiment of the present disclosure, where the method includes step S210 and step S220.

In step S210, the providing device 10 detects, in response to a request of a user to comment on an object to be commented, whether resource saving information about the object to be commented is available. If the resource saving information is available, then in step S220, the providing device 10 provides the resource saving information and the comment input mode to the user, wherein the comment input mode is for the user to input comment content about the object to be commented. If the resource saving information is not available, then in step S220, the providing device 10 provides the comment input mode to the user.

Alternatively, in step S210, the providing device 10 first obtains the user's request to comment on the object to be commented by means of dynamic page technology such as JSP or by means of an API provided by the providing device 10 itself, or obtains the request for commenting on the object to be commented by acquiring a natural language command from a user to comment on the object to be commented by a sound acquisition device (such as a microphone, etc.). Then, in response to the request, the detection module 110 detects whether resource saving information about the object to be commented is available, such as by searching in a resource saving information database based on the object content of the object to be commented, and thereby determining whether the corresponding resource saving information is available.

Here, the object to be commented may be a video, short video, picture, document, animation, etc. In this disclosure embodiment, the type of the object to be commented is not limited.

Here, the resource saving information refers to the discount information, and in practical application, the resource saving information includes, but is not limited to, at least one of the following: 1) the resource saving information being a coupon about the object content of the object to be commented; 2) the resource saving information being a cash rebate information about the object content of the object to be commented; 3) if the object to be commented being a video and the video including implicit presentation information, the resource saving information being a discount information of implicit presentation information matching the user-related information of the user. Where the implicit presentation information is the content incorporated into the object to be commented for conveying information to the user, such as a brand symbol representing a product or service incorporated into the video, where the user-related information is information that reflects the user's attributes, such as the user's gender, age, region, group, hobby, occupation, etc. Those skilled in the art should be able to understand that the above resource saving information and user-related information are examples only, and that other existing or possible future resource saving information or user-related information that may be applicable to the present disclosure should also be included within the scope of protection of the present disclosure and are hereby incorporated by reference herein.

In the optional embodiment, if the object to be commented is a video, the content of the video is the object content of the object to be commented. If the content of the video is related to gourmet food and the store corresponding to the gourmet food has promotional activities, the resource saving information may be coupons, cash rebate information, promotional information, etc. If the content of the video is about agricultural products and the origin of the agricultural products has promotional activities, the resource saving information may be coupons, discount information, promotion information, etc. For other contents of the video (such as children's playground, travel, etc.), corresponding resource saving information can be obtained by analogy, and details are not repeated one by one here for the sake of simplicity.

In an optional embodiment, if the object to be commented is a short video about the promotion of attractions in poor counties to promote local tourism and boost the development of local tourism, the content of the video incorporates a number of implicit presentation information about local food, specialties, and food production materials, etc. If the user watching the short video has a hobby of food production, the corresponding resource saving information is the information about gourmet food. If the user watching the short video is interested in food preparation, the corresponding resource saving information is the discount information about the food preparation materials matching the user's hobby, rather than the discount information of other implicit presentation information incorporated in the short video.

In an optional embodiment, for example, assuming that user A views a short video with content about gourmet food, and he/she intends to comment on the video during the watching process, and then clicks the comment button on the page, in step S210, the providing device 10 first obtains a request from user A to comment on the short video by means of dynamic page technology such as JSP; then, in step S210, the providing device 10 performs a query in the resource saving information database based on the content of the video, so as to determine whether corresponding resource saving information is available, and if in step S210, the providing device 10 queries in the resource saving information database and finds that the store corresponding to the gourmet food has discount information, then it can be judged that corresponding resource saving information is available.

Those skilled in the art should be able to understand that the above-mentioned ways of obtaining a user's request to comment on a subject to be commented on are only examples, and other existing or possible future ways of obtaining a user's request to comment on a subject to be commented on, if applicable to the present disclosure, should also be included within the scope of protection of the present disclosure, and are hereby included by reference herein.

It should be understood by those skilled in the art that the foregoing means of detecting the availability of resource saving information about the object to be commented is only an example, and that other existing or possible future means of detecting the availability of resource saving information about the object to be commented, if applicable to the present disclosure, should also be included within the scope of the present disclosure, and are hereby incorporated by reference herein.

If the resource saving information is available, in step S220, the providing device 10 provides the resource saving information and the comment input mode to the user via an agreed communication method such as http, https, etc., wherein the comment input mode is for the user to input the comment content about the object to be commented.

Here, the comment input mode may be a GUI interactive input mode, such as a comment text input box, or a voice interactive input mode, such as a microphone icon indicating a voice input function.

In an optional embodiment, if the comment input mode is a comment text input box, the text style of the comment text input box is different from the page style of the comment page formed by the comment about the object to be commented. Here, the text style refers to the tone, font, and the like that reflects the formatting of the text in the comment text input box, and the style of the comment page refers to the page base color, the font of the text in the page, etc. For example, when the base color of the comment page is black, the comment text input by the user in the comment text input box is displayed in white, and when the base color of the comment page is white, the comment text input by the user in the comment text input box is displayed in black.

Here, the user's visual experience is enhanced because the text style of the comment text input box in the present disclosure is different from the page style of the comment page formed by the comment about the object to be commented.

In an optional embodiment, if the comment input mode is a comment text input box, when the resource saving information and the comment input mode are provided to the user by the providing device 10 in step S220, the resource saving information is located at the top of the comment text input box, or, the resource saving information is located at the upper part of the comment text input box and immediately adjacent to the comment text input box, or, the resource saving information is located at the at the top of the comment page. For example, assuming that user A views a short video with content about gourmet food, and he/she intends to comment on the video during the watching process, and then clicks a comment button on the page (as shown in FIG. 2), if in step S210, the providing device 10 queries the resource saving information database and finds that the store corresponding to the gourmet food has discount information, and therefore determines that it has corresponding resource saving information, then in step S220, the providing device 10 provides the resource saving information and the comment text input box to the user A. Where the resource saving information is located at the top of the comment text input box, as shown in FIG. 2. In this regard, it is noted that FIG. 2 only exemplarily illustrates the case where the resource saving information is located at the top of the comment text input box, and the comment text input box in FIG. 2 hovers above the video window viewed by the user, which is also only exemplary and should not be interpreted as limiting the present disclosure. In practical applications, the location relationship between the comment text input box and the video window viewed by the user can be arbitrary and will not be limited here.

When the resource saving information and the comment input mode are provided to the user, the resource saving information is located at the top of the comment text input box, or the resource saving information is located at the upper portion of the comment text input box and immediately adjacent to the comment text input box, or the resource saving information is located at the top of the comment page, so that the user can immediately know the resource saving information, the efficiency of users to obtain information is further improved, and the user experience is further enhanced.

In an optional embodiment, if the comment input mode is a voice interactive input mode, then in step S220, the resource saving information is located at the top of the comment page formed by the comments about the object to be commented when the providing device 10 provides the resource saving information and the comment input mode to the user.

If the resource saving information is not available, then in step S220, the providing device 10 provides the comment input mode to the user.

Based on the same principles as the method for providing the comment input mode in embodiments of the present disclosure, embodiments of the present disclosure also provide an electronic device that may include, but is not limited to: one or more processors; a memory that is used to store one or more programs; and a method that implements the method shown in the above embodiments when the one or more programs are executed by the one or more processors.

Based on the same principles as the methods for providing comment input modes in embodiments of the present disclosure, there is also provided in embodiments of the present disclosure a computer-readable storage medium having a computer program stored thereon, wherein the program implements the methods shown in the above embodiments when executed by the processors, which will not be repeated herein.

FIG. 4 is a schematic diagram of the structure of an exemplary electronic device suitable for use in implementing an embodiment of the present disclosure, which may be a terminal device 400. The terminal device can be any electronic product that can interact with the user both by voice interaction and by non-voice interaction such as a keyboard, touch pad, touch screen, remote control or handwriting device, such as a PC, mobile phone, smart phone, PDA, wearable device, PDA, vehicle terminal, smart wearable device, tablet computer, smart voice car device, smart voice TV, etc. The electronic device illustrated in FIG. 4 is merely exemplary and should not impose any limitations on the functionality and scope of use of embodiments of the present disclosure.

As shown in FIG. 4, the electronic device 400 may include a processing device 401 (e.g., central processor, graphics processor, etc.) that may perform various appropriate actions and processes based on a program stored in a read-only memory (ROM) 402 or loaded from a storage device 408 into a random access memory (RAM) 403. In RAM 403, various programs and data required for the operation of electronic device 400 are also stored. The processing device 401, the ROM 402, and the RAM 403 are connected to each other via a bus 404. The input/output (I/O) interface 405 is also connected to the bus 404.

Typically, the following devices may be connected to the I/O interface 405: an input device 406 including, for example, a touch screen, a touch pad, a keyboard, a mouse, a camera, a microphone, an accelerometer, a gyroscope, etc.; an output device 407 including, for example, a liquid crystal display (LCD), a speaker, a vibrator, etc.; a storage device 408 including, for example, a magnetic tape, a hard disk, etc.; and a communication device 409. The communication device 409 may allow the electronic device 400 to perform wireless or wired communication with other devices to exchange data. Although FIG. 4 illustrates the electronic device 400 with various devices, it should be understood that it is not required to implement or have all of the devices illustrated. More or fewer devices may alternatively be implemented or available.

In particular, according to an embodiment of the present disclosure, the process described above with reference to the flowchart may be implemented as a computer software program. For example, embodiments of the present disclosure include a computer program product comprising a computer program carried on a computer-readable medium, the computer program comprising program code for performing the method shown in the flowchart. In such an embodiment, the computer program may be downloaded and installed from a network via a communication device 409, or from a storage device 408, or from a ROM 402. When the computer program is executed by the processing device 401, the above-described functions as defined in the method of the embodiments of the present disclosure are performed.

It is to be noted that the computer-readable medium described above in the present disclosure may be a computer-readable signal medium or a computer-readable storage medium or any combination of the above. A computer-readable storage medium may be, for example, but not limited to, an electronic, magnetic, optical, electromagnetic, infrared, or semiconductor system, apparatus, or device, or any combination of the foregoing. More specific examples of the computer-readable storage media may include, but are not limited to: electrically connected with one or more wires, portable computer disks, hard disks, random access memory (RAM), read-only memory (ROM), erasable programmable read-only memory (EPROM or flash memory), optical fiber, portable compact disk read-only memory (CD-ROM), optical storage devices, magnetic memory devices, or any suitable combination of the foregoing. In this disclosure, a computer-readable storage medium can be any tangible medium containing or storing a program, which can be used by or in connection with an instruction execution system, apparatus or device. In this disclosure, the computer-readable signal medium may include a data signal propagated in baseband or as a part of a carrier wave, in which the computer-readable program code is carried. This propagated data signal can take various forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program code contained on the computer-readable medium can be transmitted using any suitable medium, including but not limited to: wire, fiber optic cable, RF (radio frequency), etc., or any suitable combination of the above.

The computer readable medium may be included in the electronic device; or it may exist alone and not be assembled into the electronic device.

The above computer-readable medium carries one or more programs which, when executed by the electronic device, cause the electronic device to perform the method for providing the comment input mode shown in the method embodiment above.

The computer program code for performing the operations of the present disclosure may be written in one or more programming languages or combinations thereof, the programming languages including object-oriented programming languages-such as Java, Smalltalk, C++, and also including conventional procedural programming languages-such as “C” language or similar programming languages. The program code may be executed entirely on the user's computer, partially on the user's computer, as a stand-alone package, partially on the user's computer and partially on a remote computer, or entirely on a remote computer or server. In the case of a remote computer, the remote computer may be connected to the user computer over any kind of network-including a local area network (LAN) or a wide area network (WAN)-or, alternatively, may be connected to an external computer (e.g., using an Internet service provider to connect over the Internet).

The flowcharts and block diagrams in the accompanying drawings illustrate the possible architectures, functions, and operations of the systems, methods, and computer program products according with various embodiments of the present disclosure. In this regard, each block in the flowchart or block diagram may represent a module, a program segment, or a part of code containing one or more executable instructions for implementing specified logical functions. It should also be noted that in some implementations as replacements, the functions indicated in the boxes may also occur in a different order than that indicated in the accompanying drawings. For example, two boxes represented one after the other can actually be executed in substantially parallel, and they can sometimes be executed in the opposite order, depending on the function involved. Note also that each box in the block diagram and/or flowchart, and the combination of boxes in the block diagram and/or flowchart, may be implemented with a dedicated hardware-based system that performs the specified function or operation, or may be implemented with a combination of dedicated hardware and computer instructions.

The units described in the embodiments of the present disclosure may be implemented by means of software, or they may be implemented by means of hardware. For example, the first acquisition unit may also be described as “a unit for acquiring at least two Internet protocol addresses”.

The above description is only a preferred embodiment of the present disclosure and an illustration of the technical principles employed. It should be understood by those skilled in the art that the disclosure scope involved in this disclosure is not limited to the technical scheme formed by the specific combination of the above technical features, but also covers other technical schemes formed by any combination of the above technical features or their equivalent features without departing from the above disclosure concept. For example, the technical scheme formed by replacing the above features with the technical features with similar functions disclosed in this disclosure (but not limited to).

It should be understood that although each step in the flowchart of the drawings is displayed in sequence as indicated by the arrow, these steps are not necessarily executed in sequence as indicated by the arrow. Except as expressly stated herein, there is no strict sequential limitation on the execution of these steps, which may be performed in any other order. Moreover, at least some of the steps in the flowchart of the accompanying drawings may include a plurality of sub-steps or a plurality of phases, which are not necessarily executed at the same moment of completion, but may be executed at different moments, and the order of their execution is not necessarily sequential, but may be executed in rotation or alternately with other steps or at least some of the sub-steps or phases of other steps.

The foregoing is only a partial embodiment of the present invention, and it should be noted that, for those skilled in the art, various modifications and embellishments can be made without departing from the principle of the present invention, and these should also be construed as the scope of the present invention.

1. A method for providing a comment input mode, comprising:
detecting, in response to a request of a user to comment on an object to be commented, whether resource saving information about the object to be commented is available;
if the resource saving information is available, providing the resource saving information and the comment input mode to the user, wherein the comment input mode is for the user to input comment content about the object to be commented;
if the resource saving information is not available, providing the comment input mode to the user.

2. The method of claim 1, wherein the resource saving information comprises at least one of the following:
a coupon about the object content of the object to be commented;
a cash rebate information about the object content of the object to be commented;
if the object to be commented is a video and the video includes implicit presentation information, the resource saving information is discount information of the implicit presentation information matching user-related information of the user.

3. The method of claim 1, wherein, if the comment input mode is a comment text input box, the text style of the comment text input box is different from a page style of a comment page formed by a comment about the object to be commented.

4. The method of claim 3, wherein the providing the resource saving information and the comment input mode to the user comprises at least one of the following:
providing the resource saving information and the comment input mode to the user, wherein the resource saving information is located at a top of the comment text input box;
providing the resource saving information and the comment input mode to the user, wherein the resource saving information is located at an upper portion of and immediately adjacent to the comment text input box;
providing the resource saving information and the comment input mode to the user, wherein the resource saving information is located at the top of the comment page.

5. A providing device for providing a comment input mode, comprising:
a detection module configured to detect, in response to a request of a user to comment on an object to be commented, whether resource saving information about the object to be commented is available; and
a providing module configured to:
if the resource saving information is available, provide the resource saving information and the comment input mode to the user, wherein the comment input mode is for the user to input comment content about the object to be commented,
if the resource saving information is not available, provide the comment input mode to the user.

6. The providing device of claim 5, wherein the resource saving information comprises at least one of the following:
a coupon about object content of the object to be commented;
a cash rebate information about the object content of the object to be commented;
if the object to be commented is a video and the video includes implicit presentation information, the resource saving information is discount information of the implicit presentation information matching user-related information of the user.

7. The providing device of claim 5, wherein, if the comment input mode is a comment text input box, a text style of the comment text input box is different from a page style of a comment page formed by a comment about the object to be commented.

8. The providing device of claim 7, wherein providing the resource saving information and the comment input mode to the user comprises at least one of the following:
the resource saving information is located at a top of the comment text input box;
the resource saving information is located at a top of the comment page.

9. An electronic device, comprising:
one or more processors; and
a memory configured to store one or more programs,
wherein the one or more programs, when executed by the one or more processors, causes the one or more processors to perform a method of claim 1.

10. A computer-readable storage medium having a computer program stored thereon, wherein the computer program, when executed by a processor, implements a method of claim 1.
